(19) United States
(12) Patent Application Publication
(10) Pub. No.: US 2001/0031305 A1
(43) Pub. Date: Oct. 18, 2001

(54) HOP EXTRACT OF DEFINED COMPOSITION

(76) Inventors: MICHAEL SMITH, YAKIMA, WA (US); DAVID DIFFOR, BEIGEM (BE); ROBERT MILLER, MOXEE, WA (US)

Correspondence Address: CHRIS E SVENDSEN, STRATTON BALLEW PLLC, 213 SOUTH 12TH AVENUE, YAKIMA, WA, 98902

(21) Appl. No.: 09/309,396

(22) Filed: May 7, 1999

(51) Int. Cl. C12C 3/08

(52) U.S. Cl. 426/600

(57) ABSTRACT

A hop extract product of specific and predefined composition is provided that is specifically an enriched alpha-acid hop extract product having a total alpha-acids concentration greater than 60% by weight, a total beta-acids concentration of less than 20% by weight, and a total hop essential oil concentration in excess of 1% by weight, and a process for manufacturing such an enriched extract. The process includes extracting a raw hop to produce a whole hop extract with a portion of the whole hop extract refined to form a purified alpha acids product, which is utilized to supplement the whole hop extract or the beta-acids and oils to form an enriched alpha-acid hop extract product. This enriched extract is uniform and precisely standardized, containing invariable and exact quantities of specifically desired flavoring components. The alpha enriched extract product also has better stability than the high purity alpha-acids fraction.

### TECHNICAL FIELD

The invention relates the manufacture of a hop extract having a defined composition, and more particularly to a process for providing a hop extract product having a high, enriched level of alpha-acids.

### BACKGROUND OF THE INVENTION

Hops impart the required and characteristic bitter flavor to beer. To facilitate the commercial production of beer, the essential flavor components of the hops can be extracted in bulk, thereby forming a hop extract. The composition and quality of this hop extract product can vary considerably, depending on the solvent employed for the extraction and the post extraction processing utilized to further modify and enhance the extract. The hop extract typically includes most of the oils, resins, fats and waxes that were present in the original hops. Alpha-acids are a vital flavoring component of the hop extract. These alpha-acids are also commonly called humulones, including humulone, co-humulone, ad-humulone and post-humulone.

Preferably, the hop extract is produced with processes that utilize CO₂, which performs as a solvent under either sub-critical liquid or supercritical conditions. CO₂ hop extracts are popular with brewers because they are intrinsically free from organic solvent residues. Additionally, CO₂ hop extracts are chemically stable and easily transported, stored and dosed in the brewing process, especially when compared with raw hops or hop pellets. Hop extracts are commonly purchased by brewers or brewers' agents, according to the tastes of the brewer, in either a generic extract form or a varietal extract form. These purchasers of generic hop extracts are sensitive to the amount of alpha-acid being purchased, while the variety of hop from which the extracts are derived is irrelevant. Brewers especially have distinct preferences for extracts of specific hop varieties. In either case, there is a strong desire by the brewer to obtain the most homogeneous product possible.

The chemical composition of hop extracts generally varies less than the composition of the original hops. This is primarily the result of extract concentrating, and the in-process mixing, averaging and homogenizing of extractable resins, waxes and oils. The normal variation over a series of hop processing lots is greatly reduced when the hops are extracted and the resulting liquid concentrate blended before packaging. However, some variation in the chemical component percentages of the extract will persist from lot to lot, even within the same variety. Some brewers desire a product of greater uniformity than can result from normal processing, as described above. This uniformity is desired to increase process control within the brewery. Such a level of hop extract product control is currently unavailable. It would, therefore, be desirable to provide brewers with a consistent hop extract product, and more specifically, a hop extract product that exhibits invariable and exact quantities of the desired flavoring components.

An attempt at an improved product control for hop extracts is found in U.S. Pat. No. 3,298,835 to Hildebrand et al. In Hildebrand '835, a two-phase, organic/aqueous extraction process is proposed, with subsequent purification and processing of individual components. The hop extract is mixed with a dilute aqueous solution of alkali to form an aqueous phase and an organic phase. The aqueous phase includes the alpha-acids, or humulones, which are then heated in a reactor to form iso-humulone. The organic phase also passes into a reactor, where it is oxidized. Hildebrand '835 then suggests the recombining and homogenization of these two separate fractions for eventual addition to the brewer's wort or to a brewed beverage. The process described by Hildebrand '835 employs unacceptable organic solvents, requires extensive processing of the hop oil fraction and simply teaches the processing of the separated extract fractions, which are then reassembled in a hop concentrate final product. This final downstream product mixture of Hildebrand '835, can only be altered by varying the parameters in each specific processing step described therein. Once the process is optimized, the Hildebrand '835 process produces a final product with much the same lot to lot variations as are found in the raw hops. A greater level of uniformity and product control is needed, especially a control that can be implemented by the extract processor, which takes into account the inherent variability of the raw hop material, to achieve a truly homogeneous hop extract product.

Similarly, U.S. Pat. No. 3,364,265 to Klingel et al. contemplates “made-to-order” mixtures for production of malt beverages as an object but fails to provide a description or examples for such mixtures. The scope of Klingel '265 is limited entirely to the process of fractionating an organic solvent hop extract. Like Hildebrand '835, Klingel '265 focuses on obtaining pure forms of alpha-acids and beta-acids, and iso-humulone. However, Klingel '265 also uses water extraction to obtain a tannin fraction from the residue of the organic extraction, and a generalized distillation of hop essential oils from the extraction's organic phase. The Klingel '265 process has many of the same shortcomings as observed in Hildebrand '835. Klingle '265 teaches the use of unacceptable organic solvents, and further teaches process control through the maintenance of separate fractions for individually metered introduction to downstream brewery processes. A further failing of the Klingle '265 process is its retention of alpha-acids in a pure form. It is well known to practitioners of the art that purified alpha-acids are highly unstable and, if left standing without further processing, degrades into off-flavored or flavorless by-products.

Klingel '265 does disclose the utilization of an alkali hydroxide, preferably sodium hydroxide, for recovery of the alpha-acids component from the hop extract. Klingel '265 specifies the addition of a stoichiometric amount of the alkali hydroxide to the hop extract, based on the estimated amount of alpha-acids in the extract. This technique is widely employed with excellent yields and high purity. For example, U.S. Pat. No. 4,590,296 to Cowles et al. describes this same process step in the separation of a CO₂ extract into alpha-acid and beta-acid fractions. Cowles '296 also utilizes an alkali hydroxide for alpha-acids recovery, specifically potassium hydroxide, in a 1:1 equivalent ratio to the alpha-acids in the raw, whole CO₂ extract.

An early effort to apply the concept of fraction enrichment to CO₂ hop extract is found in U.S. Pat. No. 4,344,978 to Sharpe et al. Sharpe '978 utilizes the chromatographic properties of liquid CO₂ extraction to select fractions rich in individual components during process elution. A fraction rich in essential hop oils is recovered first, followed sequentially by a beta-acid rich fraction and then an alpha-acid rich fraction.

The Sharpe '978 process avoids the use of objectionable solvents and the probable modifications induced on the hop oil profile by distillation. However, while Sharpe '978 confers the advantage of single-stage isolation of component rich fractions, it is fundamentally lacking in its ability to provide fixed component profile products on demand. Although Sharp '978 teaches that this process makes it possible to prepare fractions according to the particular need of brewing companies, a number of factors inherent in practical processing preclude this possibility. The Sharpe '978 method is sensitive to particle size of the hop grist extracted. As particle size varies, the retention time of each component is accordingly influenced. Also, as different hop varieties possess different component amounts and inter-component ratios, the processed fractional composition will be similarly affected. A consistent product component profile of alpha-acids, beta-acids and essential oils is a matter of constant process monitoring and an exact selection of fractions. The variable process of Sharp '978 is not capable of practically delivering a fixed profile product with consistency. Also, the component profile of the Sharp '978 extraction product, as finally recovered, provides a limited and fixed range of end use options.

To further illustrate this limited and fixed range of products, Sharp '978 does not allow for the obtaining of a product with alpha-acids content above approximately 60% and a beta-acids content below 20%, while retaining a meaningful essential oil content. Hampered by intrinsic process limitations, Sharp '978 is constrained to product compositions dictated by the fractionation separations of the raw extract.

Therefore, it would be desirable to manufacture a whole hop extract product that includes a consistent and exact level of beta-acids in conjunction with a high alpha concentration and additional quantities of essential oils, in user desired concentrations not dictated by fractionation.

The invention as described in examples below overcomes these limitations and provides significant advantages to the brewer.

### SUMMARY OF INVENTION

The present invention provides hop extract products of specific and predefined composition. Specifically, an enriched alpha-acids hop extract product is provided having a total alpha-acids concentration greater than 60% by weight, a total beta-acids concentration of less than 20% by weight, and a total hop essential oils concentration in excess of 1% by weight. The process of the present invention includes the steps of extracting a raw hop to produce a whole hop extract. At least a portion of the whole hop extract is then refined to form a purified alpha-acids product. The purified alpha-acids are then utilized to supplement the whole hop extract. This process produces an alpha enriched extract product having a total alpha-acids concentration greater than 60% by weight, a total beta-acids concentration less than 20%, by weight, and a total hop essential oils concentration in excess of 1% by weight.

Additionally, extracted fractions having a higher purity of alpha-acids may be added to further fortify the alpha-acid content of a varietal extract.

Instead of combining the alpha acids with the whole hop extract, the process for preparing the alpha enriched extract product can alternatively include combining a controlled mixture of the purified alpha-acids with a refined fraction of the whole hop extract that is composed largely of beta-acids and oil.

According to one aspect of the invention, a uniform and precisely standardized hop extract product is provided, especially for the brewer, who typically requires a consistent hop extract product. The hop extract product of the present invention contains invariable and exact quantities of specifically desired flavoring components.

According to another aspect of the invention, the hop extract product provides a high level of uniformity and product control for the extract processor, who can with the present invention take into account the inherent variability of the raw hop material, thereby achieving a truly homogeneous hop extract product. This provides the brewer with greater consistency and economy of bittering without loss of varietal character in the finished beer. The alpha enriched extract product also has better stability than the high purity alpha-acids fraction.

### BRIEF DESCRIPTION OF THE DRAWING

FIG. 1 is a schematic diagram of a preferred process of the present invention.

### DETAILED DESCRIPTION OF SPECIFIC EMBODIMENTS

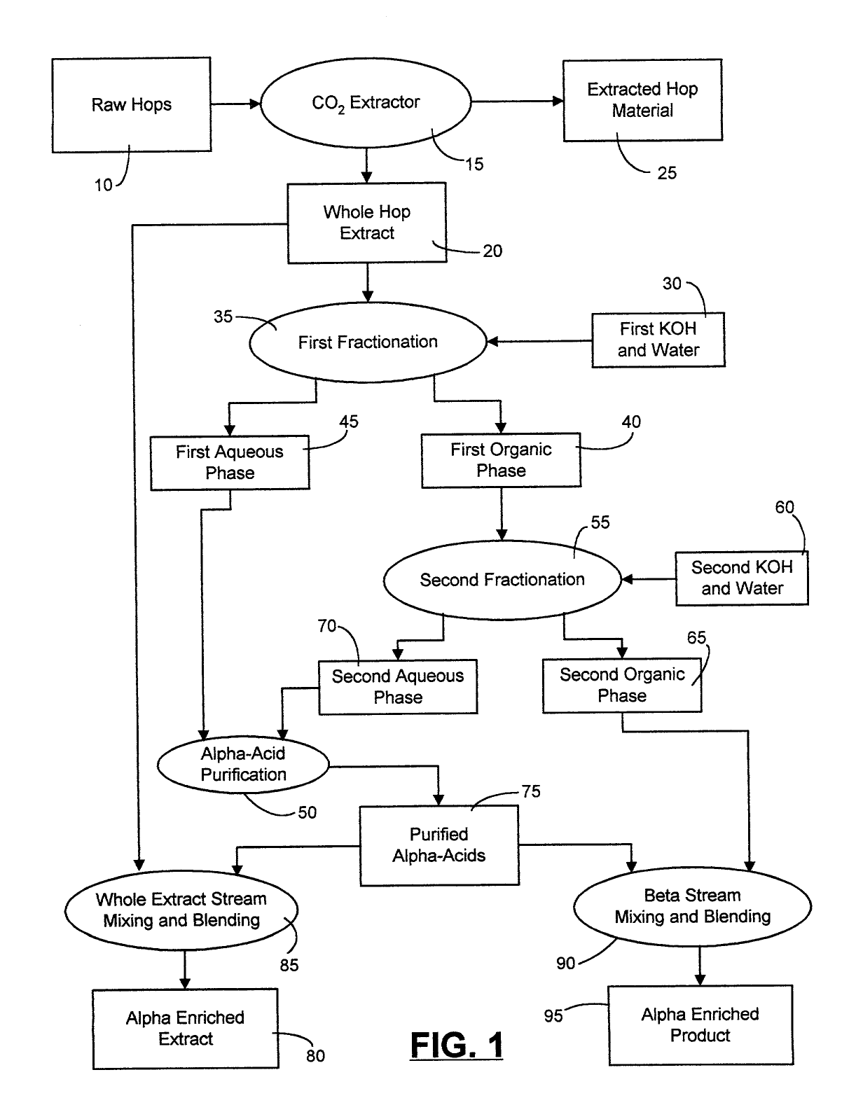

The invention provides a hop extract product that is manufactured by the selective re-assembly of the two main fractions of a whole extract of a raw hop material. The alpha-acids component is then utilized for the standardization of a generic hop extract to a precisely fixed level of alpha-acids content. FIG. 1 shows this process schematically, with the raw hops 10 introduced into the CO₂ extractor 15, to produce a whole hop extract. The raw hops are preferably dried and pelletized prior to extraction. Once the essential oils and flavors are extracted, the extracted hop materials 25 can be re-pelletized and employed in a variety of uses, including a feed product for livestock. The extracted hop material primarily includes the cellulosic components of the raw hops.

Strictly following the teachings of U.S. Pat. No. 3,364,265 to Klingel et al., the fractionation of the whole hop extract 20 into constituent components is achieved. Preferably, for the present invention the whole hop extract is a product of a CO₂ extraction, and most preferably a supercritical CO₂ extraction. According to Klingel '265, one volume of the whole hop extract is extracted with one equivalent of an alkali hydroxide in approximately two volumes of water. The equivalent of the alkali hydroxide is preferably at or above the alpha-acids concentration in the volume of the whole hop extract. Most preferably for the present invention, potassium hydroxide is utilized as the alkali hydroxide in approximately a 1:1 equivalent ratio to the alpha acids in the volume of whole hop extract. FIG. 1 shows this potassium hydroxide and water solution as a “first KOH and water” 30.

This basified mixture of the whole hop extract 20 and the first KOH and water 30 is stirred at 50° C. to 55° C. for approximately 15 minutes. The mixture fractionates into a first aqueous solution, containing substantially all of the alpha acids, beneath a separate oil layer. The oil layer contains the remainder of the alpha-acids, all of the beta acids, and the hop oils and waxes originally present in the whole hop extract. FIG. 1 refers to this extraction as a “first fractionation” 35. The oil layer is designated as a “first organic phase” 40 and the aqueous solution is referred to as a “first aqueous phase” 45.

After the first fractionation 35, at least 80% of the alpha-acids initially present in the whole hop extract 20 are concentrated within the first aqueous phase and can be separated and recovered in an alpha-acid purification 50. A second extraction is then preferably performed on the first organic phase 40. In the second extraction, referred to herein as a second fractionation 55, one volume of the first organic phase is combined with 1.5 equivalents of potassium hydroxide and two volumes of water 60, per equivalent of the remaining alpha-acids within the one volume of the first organic phase. FIG. 1 shows this second potassium and water solution as a “second KOH and water” 60. A second aqueous solution is thereby formed, having an oil layer, designated herein as a “second organic phase” 65 over a second solution referred to as a “second aqueous phase” 70.

The second aqueous phase 70 contains a maximum of 20% of the alpha-acids originally present in the whole hop extract 20 and a maximum of 20% of the beta-acids contained in the first organic phase 40. The second organic phase 65 contains only beta-acids, hop oils, hard resins and waxes of the original whole hop extract.

The alpha-acids present in first aqueous phase 45 of the first fractionation 35 and second aqueous phase 70 of the second fractionation 55 are combined and purified in the alpha-acid purification 50. This purification results in a purified alpha-acids 75 and can be achieved by acidification and mixing of the alpha acids from the first fractionation 35 and the second fractionation 55. The acidifying purification of the combined first aqueous phase 45 and the second aqueous phase 70, is preferably achieved with a quantity of sulfuric acid sufficient to approximately neutralize the first potassium hydroxide in water 30 added in the first fractionation, and the second potassium hydroxide in water 60 added to the second fractionation 55. In this acidification, the alpha-acids revert to their water insoluble form and the purified alpha-acids can then be concentrated by filtering and/or drying.

The purified alpha-acids 75 are preferably stored prior to a whole extract stream mixing and blending 85 with the whole hop extract 20, as shown in FIG. 1. Substantially all of the alpha-acids present in the aqueous solutions are now available as the purified alpha-acids. Preferably, to minimize degradation of the unstable purified alpha-acids 75, the purified alpha-acids are only temporarily stored. Most preferably even temporary storage of the purified alpha-acids is performed under refrigerated conditions. The temporary cold-storage of the purified alpha-acids insures that no significant degradation occurs. Even so, the purified alpha-acid extract is preferably quickly utilized to supplement whole hop extracts 20 to form an alpha enriched extract 80.

Alternatively, for additional control and product options in the process of the present invention, the purified alpha-acids 75 can be mixed and blended in desired proportions with the second organic phase 65, instead of the whole hop extract 20. This mixing and blending is referred to a “beta stream mixing and blending” 90 in FIG. 1. Through mixing the purified alpha-acids with second organic phase, an alternative alpha enriched product 95 is formed.

As discussed above, the second organic phase 65 is rich in beta-acids, and can be referred to as a beta-acids rich fraction. It contains substantially all of the beta-acids, hop oils and waxes present in the whole hop extract 20, as refined in the first fractionation 35 and the second fractionation 55. Therefore, by mixing and blending the second organic phase and the purified alpha-acids, the alpha enriched product 95 can be tailored to meet specific, preselected ratios of alpha-acids to beta-acids and oils. Such specific ratios may be required by a brewery or other user of the alpha enriched extract to achieve a desired product consistency and/or flavoring characteristics. With this alternative embodiment of the present invention, these specific, preselected ratios can be provided irrespective of the ratio or concentrations of alpha-acids to beta-acids in the original whole hop extract.

The quantity of purified alpha-acids 75 added to any particular batch of the whole hop extract 20 or added to a quantity of the second organic phase 65 is based on the desired alpha-acids concentration of the alpha enriched extract 80 or alpha enriched product 95, respectively. In the process of enriching of the whole hop extract, this desired concentration is compared with the originally assessed concentration of the alpha-acids present in the whole hop extract, and the required amount of purified alpha-acids is mixed and blended 85 into the whole hop extract. For example, if a particular lot of the whole hop extract has an alpha-acids concentration of 55% by weight, which is common for many CO₂ extracts of high alpha-acid hop varieties, an additional equal weight of the purified alpha-acid could be added to bring the concentration of the alpha-acids in the now enriched alpha enriched extract to 60% by weight.

In the alternative process of enriching the second organic phase 65 beta stream of the whole hop extract 20 with the purified alpha acids 75, the enrichment of the beta stream can be precisely controlled. The enrichment of the second organic phase 65 is preferably performed with knowledge of the original alpha-acids concentration in the purified alpha-acids. This alpha-acid concentration is most preferably employed to dictate the required amount of the second organic phase to be mixed and blended with the purified alpha-acids in the beta stream mixing and blending 90 for achieving a desired concentration of the alpha-acids in the alpha enriched product 95.

For the present invention, the concentrations of the various extract and enriched extract components are reported herein as weight to weight percentages, as preferably determined by high performance liquid chromatography (HPLC) against the 2^{nd} International Calibration Extract (ICE-2) standard.

Alternatively, a wide range of concentrations of alpha-acid, which is above the low levels present in whole hop extracts 20 can be achieved with the present invention. This ability is tempered only with the provision that the preserving qualities of the non-alpha-acid components will likely diminish as the alpha-acids concentrations approach the concentration of the purified alpha-acids 75.

The alpha enriched extract 80 is also expected to be a great benefit in the extended storage of alpha-acids. As discussed herein, the stability of substantially pure alpha-acids over time is a significant problem. Concentrated alpha-acids stored in a purified form quickly degenerate into off-flavor or flavorless products. However, the alpha-acid components of whole hop extracts 20 are apparently stabilized by the non-alpha-acid constituents of the extract and have a much longer shelf life. Somehow, the mechanism that preserves the alpha-acid constituents in the whole hop extract also preserves the supplemented, purified alpha-acids 75. The mechanism for this stabilization is not fully understood. The inventors of the present invention believe that the mechanism by which pure alpha acids degrade is moderated by equilibrium factors in the whole hop extract. Essentially, it is believed that the whole hop extract contains materials that considerably slow the degradation of alpha-acids because the products of such alpha-acid degradations are already present in near equilibrium concentrations. Substantially pure alpha-acids, which lack these stabilizers, are forced to degrade until enough of these degradation by-products are present to slow the degradation process. Therefore, the inventors of the present invention predict that the enriched alpha-acid product will exhibit long term storage characteristics more similar to the whole hop extract than to the purified alpha-acids. This stabilizing preservation takes place even when the alpha-acid constituent has been supplemented with significant quantities of the alpha-acids that were not originally present in that particular lot of whole hop extract.

This preservation is a great advantage in the long-term storage of alpha-acids. The supplemented, or enriched, alpha-acid product can be made from low alpha-acid varieties, selected for their aroma properties, and supplemented with alpha-acids to make the extract a concentrated and efficient source of alpha-acids. In this manner, the brewer can obtain the best of both aroma varieties and high alpha-acid varieties, with consistency and value.

Relatedly, an economic benefit can be realized in the shipping and storage of the enriched alpha-acid extract. The concentrated extract requires less storage space than whole extract. Additionally, compared with conventional purified alpha-acid products, the enriched alpha extract has an improved consistency of product and greater flowability at ambient temperatures.

An additional benefit of the alpha enriched extract 80, which is expected to be proven in a brewery test, is that the addition of the purified alpha-acids 75 to the whole hop extract 20 will correspondingly reduce the concentration of original non-alpha-acid component fractions. Reduction of the oil content in a high-oil varietal extract will help improve boiling performance, decrease “trub” or wort precipitates and enhance fermentation performance by maintaining fermentation within desired parameters.

The inventors of the present invention expect that a deliberate and controlled admixture of purified alpha-acids will provide a product of many advantages to the brewer with the respect to economy, consistency and materials handling. Alternatively, extracted fractions of even higher purity of alpha-acids (>70%, by weight) may be added to fortify the alpha-acids content of a varietal extract. This product control provides the brewer with greater consistency and economy of bittering without loss of varietal character in the finished beer. The alpha-enriched extract product also has better stability than the highest purity fractions of alpha-acids.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible which employ the same inventive concepts as described above. Therefore, the invention is not to be limited except by the following claims, as appropriately interpreted in accordance with the doctrine of equivalents.

What is claimed is:

1. An enriched alpha-acid hop extract product having:
a total alpha-acids concentration greater than 60% by weight;
a total beta-acids concentration of less than 20% by weight; and
a total hop essential oils concentration in excess of 1% by weight.

2. The enriched alpha-acid hop extract product of claim 1, wherein the total alpha-acids concentration is approximately 70% by weight.

3. A process for producing an enriched alpha-acid hop extract product comprising the steps of:
a) extracting a raw hop to produce a whole hop extract, the whole hop extract including alpha-acids, beta acids, hop essential oils, hard resins and waxes;
b) refining a portion of the whole hop extract to form a purified alpha acids product; and
c) supplementing the whole hop extract with the purified alpha-acids product to form an enriched alpha-acid hop extract product having a total alpha-acids concentration greater than 60% by weight, a total beta-acids concentration less than 20% by weight, and a total hop essential oils concentration in excess of 1% by weight.

4. The process for producing an enriched alpha-acid hop extract product of claim 3, wherein the step of supplementing the whole hop extract with the purified alpha-acids product to form an enriched alpha-acids hop extract product additionally includes supplementing the whole hop extract with the purified alpha-acids product to form an enriched alpha-acids hop extract product having a total alpha-acids concentration of approximately 70% by weight.

5. The process for producing an enriched alpha-acid hop extract product of claims 3, wherein the step of refining a portion of the whole hop extract to form a purified alpha-acids product includes:
b1) fractionating the whole hop extract in a first fractionation, the first fractionation including the addition of a first alkali hydroxide and water solution to the whole hop extract to form a first aqueous phase and a first organic phase;
b2) fractionating the first organic phase in a second fractionation, the second fractionation including the addition of a second alkali hydroxide and water solution to the first organic phase to form a second aqueous phase and a second organic phase; and
b3) utilizing the second organic phase as a beta-acids rich fraction.

6. The process for producing an enriched alpha-acid hop extract product of claim 3, wherein the step of refining a portion of the whole hop extract to form a purified alpha acids product additionally includes:
b4) acidifying the purified alpha-acids to substantially neutralize the first alkali hydroxide and water solution and the second alkali hydroxide and water solution; and
b5) concentrating the purified alpha-acids.

7. The process for producing an enriched alpha-acid hop extract product of claims 3, additionally including the steps of:
d) refining a portion of the whole hop extract to form a beta-acids rich fraction comprising beta-acids, hop essential oils, hard resins and waxes; and
e) recombining the beta-acids rich fraction and oil with the purified alpha-acids product to form an enriched alpha-acids hop extract product additionally having a total beta-acids concentration less than 20% by weight.

8. A process for producing an enriched alpha-acid hop extract product comprising the steps of:
a) extracting a raw hop to produce a whole hop extract, the whole hop extract including alpha-acids, beta acids and hop essential oils, hard resins and waxes;
b) refining a portion of the whole hop extract to form a purified alpha acids product; and
c) refining a portion of the whole hop extract to form a beta-acids rich fraction comprising beta-acids, hop essential oils, hard resins and waxes; and
d) recombining the beta-acids rich fraction with the purified alpha-acids product to form an enriched alpha-acids hop extract product having a total alpha-acids concentration greater than 60% by weight, a total beta-acids concentration less than 20% by weight, and a total hop essential oils concentration in excess of 1% by weight.

9. The process for producing an enriched alpha-acid hop extract product of claim 8, wherein the step of recombining the beta-acids rich fraction with the purified alpha-acids product to form an enriched alpha-acids hop extract product additionally yields an enriched alpha-acids hop extract product having a total alpha-acids concentration of approximately 70% by weight.

10. The process for producing an enriched alpha-acid hop extract product of claim 8, wherein the step of refining a portion of the whole hop extract to form a purified alpha acids product includes:
b1) fractionating the whole hop extract in a first fractionation, the first fractionation including the addition of a first alkali hydroxide and water solution to the whole hop extract to form a first aqueous phase and a first organic phase;
b2) fractionating the first organic phase in a second fractionation, the second fractionation including the addition of a second alkali hydroxide and water solution to the first organic phase to form a second aqueous phase and a second organic phase; and
b3) combining the first aqueous phase and the second aqueous phase to form a purified alpha-acids.

11. The process for producing an enriched alpha-acid hop extract product of claim 8, wherein the step of refining a portion of the whole hop extract to form a purified alpha acids product additionally includes:
b4) acidifying the purified alpha-acids to substantially neutralize the first alkali hydroxide and water solution and the second alkali hydroxide and water solution; and
b5) concentrating the purified alpha-acids.
